(19) United States
(12) Patent Application Publication
(10) Pub. No.: US 2024/0038201 A1
(43) Pub. Date: Feb. 1, 2024

(54) IMAGE DISPLAY METHOD, IMAGE DISPLAY DEVICE, AND PROGRAM

(71) Applicant: NIPPON TELEGRAPH AND TELEPHONE CORPORATION, Tokyo (JP)

(72) Inventor: Makoto MUTO, Tokyo (JP)

(73) Assignee: NIPPON TELEGRAPH AND TELEPHONE CORPORATION, Tokyo (JP)

(21) Appl. No.: 18/266,206

(22) PCT Filed: Dec. 11, 2020
(86) PCT No.: PCT/JP2020/046302

§ 371 Date: Jun. 8, 2023

(51) Int. Cl. G09G 5/30; G09G 5/36; G09G 5/37; H04N 13/395

(52) U.S. Cl. CPC G09G 5/30; G09G 5/363; G09G 5/37; H04N 13/395

(57) ABSTRACT

An image display method according to the present disclosure includes: a step of measuring a distance in a depth direction of a display target when viewed from the user (S12); and a step of displaying the display target on either the first display device or the second display device based on the measured distance (S14 and S15).

### TECHNICAL FIELD

The present disclosure relates to an image display method, an image display device, and a program.

### BACKGROUND ART

Conventionally, a method of presenting a plurality of subjects in an image (for example, a clipped image of a player in an image of a badminton game) to a viewer by a plurality of pseudo-virtual image devices (display devices) arranged in the depth direction when viewed from the viewer. According to this method, a plurality of pseudo-virtual image devices are arranged in accordance with the actual positions of the plurality of subjects in the depth direction, and the image corresponding to each subject is displayed on the pseudo-virtual image device arranged at the position corresponding to the subject. By doing so, the image of the subject actually located on the front side is displayed on the pseudo-virtual image device on the front side, and the image of the subject actually located on the back side is displayed on the pseudo-virtual image device on the back side. Thus, the viewer can get a more realistic sense of depth. Here, since a transmissive display device is used, the portion where the subject is not displayed can be seen through, so the user can visually recognize the image displayed on the pseudo-virtual image device on the back side in the transparent portion (for example, see NPL 1).

### CITATION LIST

### Non Patent Literature

[NPL 1] Takeru Isaka, Motohiro Makiguchi, and Hideaki Takada, “Kirari! for Arena” Watching a game while surrounding the competition space, NTT Technical Journal 2018.10, p 21-p 24

### SUMMARY OF INVENTION

### Technical Problem

The above method will be described in more detail with reference to FIGS. 13 to 15. FIG. 13 is a diagram showing an example of arrangement of a plurality of subjects. As shown in FIG. 13, it is assumed that a subject s1 exists at a distance T1 from an imaging device 2, and a subject s2 exists at a distance T2 from the imaging device 2 (T1>T2). Since T1>T2, the subject s1 is positioned on the back side of the subject s2 when viewed from the imaging device 2.

In the method described above, as shown in FIG. 14, a display device 3b is arranged at a distance P1 from the viewer, and a display device 3f is arranged at a distance P2 (P1>P2) from the viewer. Since P2>P1, the display device 3f is arranged on the front side of the display device 3b when viewed from the viewer. The display device 3b displays the subject s1 positioned on the back side, and the display device 3f displays the subject s2 positioned on the front side. The display device 3f and the display device 3b are arranged side by side in the depth direction when viewed from the viewer. Further, the display device 3f is configured to transmit the display image of the display device 3b so that the viewer visually recognizes the image. Therefore, as shown in FIG. 15, the display image of the display device 3b and the display image of the display device 3f are superimposed and visually recognized by the viewer. Here, by adjusting the distances P1 and P2 to the actual distances T1 and T2, respectively, the distances to the subjects s1 and s2 seen from the viewer match the distances to the actual subjects, so that the viewer can get a more realistic sense of depth.

However, in the above-described method, it was not assumed that the subject s1 on the back side and the subject s2 on the front side move widely in the depth direction.

For example, as shown in FIG. 16, when the subject s1 on the back side moves close to the subject s2 on the front side, a distance T1′ from the imaging device 2 to the subject s1 and the distance from the imaging device 2 to the subject s2 are close values. Although the distance in the depth direction between the subject s1 and the subject s2 has changed, since the distances (distances P1 and P2) from the imaging device 2 to the display devices 3b and 3f do not change, a discrepancy occurs between the distance to the actual object and the distance to the display devices 3b and 3f, making it impossible for the viewer to obtain a realistic sense of depth.

Therefore, there is a demand for a technology capable of presenting more realistic images.

An object of the present disclosure made in view of the above-mentioned problems is to provide an image display method, an image display device, and a program capable of presenting more realistic images.

### Solution to Problem

In order to solve the above problems, an image display method according to the present disclosure is an image display method in an image display device that displays a display target using a first display device and a second display device arranged on a front side of the first display device when viewed from a user so that a display image of the first display device and a display image of the second display device are superimposed and visually recognized by the user, the image display method including: measuring a distance in a depth direction of the display target when viewed from the user; and displaying the display target on either the first display device or the second display device based on the measured distance.

Further, in order to solve the above problems, an image display device according to the present disclosure is an image display device that displays a display target using a first display device and a second display device arranged on a front side of the first display device when viewed from a user so that a display image of the first display device and a display image of the second display device are superimposed and visually recognized by the user, the image display device including: a measurement unit that measures a distance in a depth direction of the display target when viewed from the user; and a display control unit that displays the display target on either the first display device or the second display device based on the distance measured by the measurement unit.

Further, in order to solve the above problems, a program according to the present disclosure causes a computer to function as the image display device described above.

### Advantageous Effects of Invention

According to the image display method, image display device, and program according to the present disclosure, it is possible to present more realistic images.

### BRIEF DESCRIPTION OF DRAWINGS

FIG. 1 is a block diagram showing a schematic configuration of a computer functioning as an image display device according to a first embodiment of the present disclosure.

FIG. 2 is a diagram showing an example of a functional configuration of an image display system including the image display device according to the first embodiment of the present disclosure.

FIG. 3 is a flowchart showing an example of the operation of the image display device shown in FIG. 2.

FIG. 4A is a diagram showing an example of movement of a subject.

FIG. 4B is a diagram showing another example of movement of a subject.

FIG. 5A is a diagram for explaining the operation of the image display device shown in FIG. 2 accompanied by the movement of the subject shown in FIG. 4A.

FIG. 5B is a diagram for explaining the operation of the image display device shown in FIG. 2 accompanied by the movement of the subject shown in FIG. 4B.

FIG. 6 is a diagram for explaining a difference in appearance of a displayed image at a reference viewing position and a non-reference viewing position.

FIG. 7 is a diagram for explaining positional deviation of a subject accompanied by switching of a display destination of the subject.

FIG. 8 is a diagram showing an example of a functional configuration of an image display device according to a second embodiment of the present disclosure.

FIG. 9A is a flowchart showing an example of the operation of the image display device shown in FIG. 8 when displaying on the display device 3b.

FIG. 9B is a flowchart showing an example of the operation of the image display device shown in FIG. 8 when displaying on the display device 3f.

FIG. 10 is a diagram showing an example of display of a subject by the image display device shown in FIG. 8.

FIG. 11 is a diagram for explaining the difference in positional deviation of the subject according to the viewer's position.

FIG. 12 is a diagram showing an example of a thinning pattern by a subject image thinning unit shown in FIG. 8.

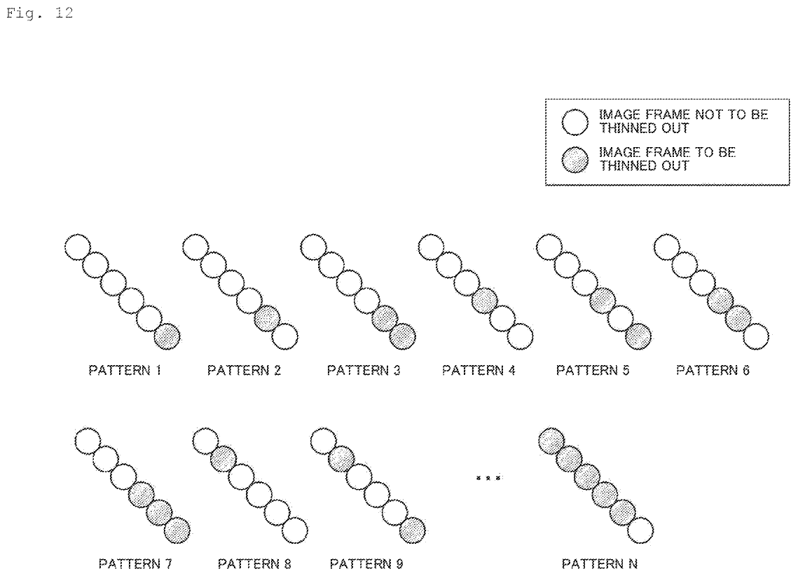

FIG. 13 is a diagram showing an example of arrangement of an imaging device and a subject.

FIG. 14 is a diagram for explaining display of a subject according to a conventional method.

FIG. 15 is a diagram showing an example of a display image by a conventional method.

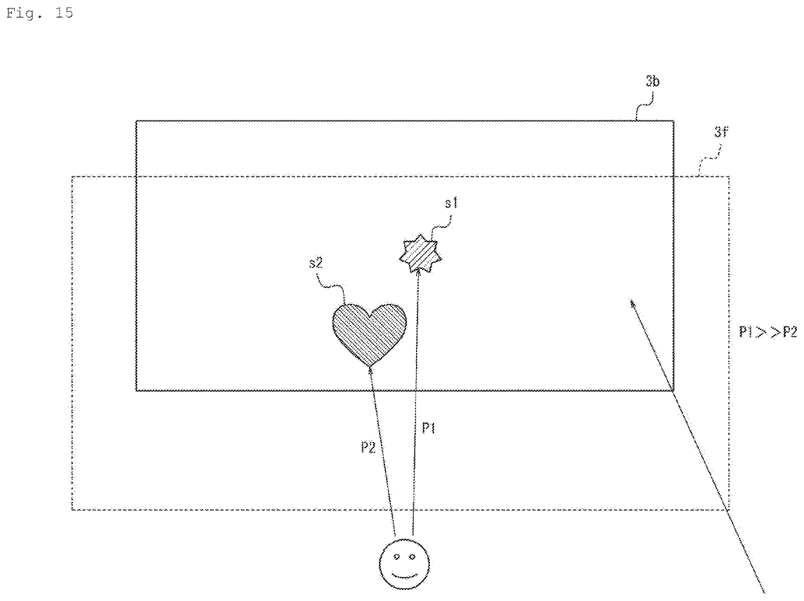

FIG. 16 is a diagram showing another example of the arrangement of the imaging device and the subject.

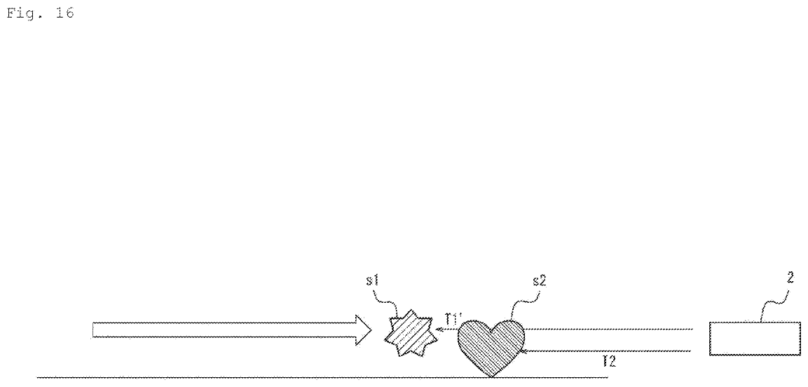

### DESCRIPTION OF EMBODIMENTS

Hereinafter, an embodiment of the present disclosure will be described with reference to the drawings.

### First Embodiment

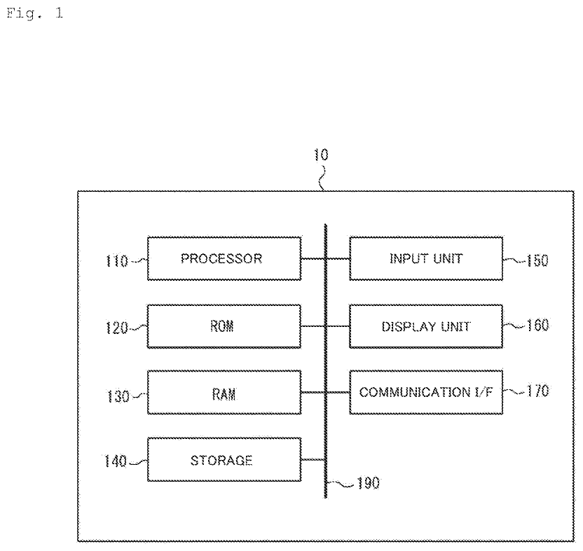

FIG. 1 is a block diagram showing a hardware configuration when an image display device 10 according to a first embodiment of the present disclosure is a computer capable of executing program commands. Here, the computer may be any of a general purpose computer, dedicated computer, work station, PC (Personal Computer), electronic notepad, and so on. The program commands may be program codes, code segments, or the like for executing necessary tasks.

As shown in FIG. 1, the image display device 10 includes a processor 110, a ROM (Read Only Memory) 120, a RAM (Random Access Memory) 130, a storage 140, an input unit 150, a display unit 160 and a communication interface (I/F) 170. The respective components are connected to each other communicably by a bus 190. Specifically, the processor 110 is a CPU (Central Processing Unit), an MPU (Micro Processing Unit), a GPU (Graphics Processing Unit), a DSP (Digital Signal Processor), an SoC (System on a Chip), and the like and may be configured by a plurality of processors of the same type or different types.

The processor 110 controls each component and executes various types of arithmetic processing. That is, the processor 110 reads a program from the ROM 120 or the storage 140 and executes the program using RAM 130 as a work area. The processor 110 performs control of each component and various types of arithmetic processing according to programs stored in the ROM 120 or the storage 140. In the present embodiment, the ROM 120 or the storage 140 stores a program according to the present disclosure.

The program may be provided by being stored on a non-transitory storage medium such as a CD-ROM (Compact Disk Read Only Memory), a DVD-ROM (Digital Versatile Disk Read Only Memory), or a USB (Universal Serial Bus) memory. In addition, the program may be downloaded from an external device over a network.

The ROM 120 stores various programs and various types of data. A program or data is temporarily stored in the RAM 130 that serves as a work area. The storage 140 is constituted by an HDD (Hard Disk Drive) or an SSD (Solid State Drive) and stores various programs, including an operating system, and various data.

The input unit 150 includes a pointing device such as a mouse and a keyboard, and is used for various inputs.

The display unit 160 is a liquid crystal display, for example, and displays various information. By employing a touch panel system, the display unit 160 may also function as the input unit 150.

The communication interface 170 is an interface for communicating with other equipment such as an external device (not shown), and, for example, standards such as Ethernet (registered trademark), FDDI, or Wi-Fi (registered trademark) are used.

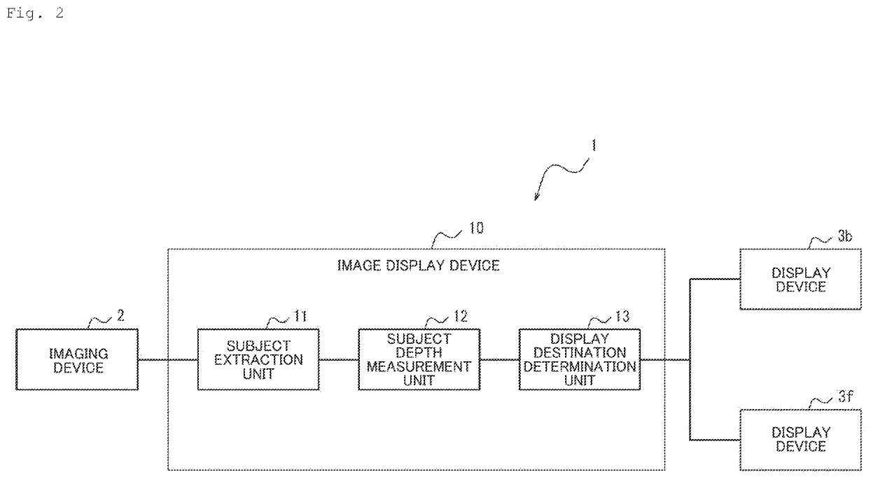

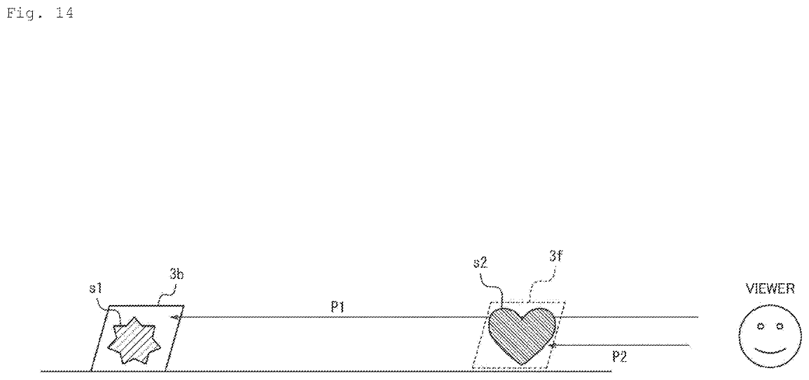

FIG. 2 is a diagram showing a functional configuration example of an image display system 1 including the image display device 10 according to the present embodiment. The image display device 10 according to the present embodiment displays a subject in an image photographed by the imaging device 2 on a plurality of display devices 3f and 3b arranged in the depth direction when viewed from the viewer (user) as shown in FIG. 14.

As shown in FIG. 2, the image display system 1 includes the imaging device 2, the display devices 3b and 3f, and the image display device 10.

The imaging device 2 is a camera that photographs a subject within a predetermined photographing range, and outputs the photographed image to the image display device 10.

The display devices 3b and 3f display images under the control of the image display device 10. As shown in FIG. 14, the display devices 3f and 3b are arranged side by side in the depth direction when viewed from the viewer (user). Specifically, the display device 3b is arranged on the back side when viewed from the viewer, and the display device 3f is arranged on the front side when viewed from the viewer. That is, the display device 3b is arranged on the back side of the display device 3f when viewed from the viewer. The display devices 3b and 3f display images in such a manner that the display image of the display device 3b and the display image of the display device 3f are superimposed and visually recognized by the viewer. The display devices 3b and 3f display (project) images by, for example, holography. However, the method of displaying images by the display devices 3b and 3f is not limited to this. Any method can be used as long as the display image of the display device 4b and the display image of the display device 4f can be superimposed and visually recognized by the viewer. Hereinafter, the display device 3b and the display device 3f are referred to as the display device 3 when not distinguished from each other.

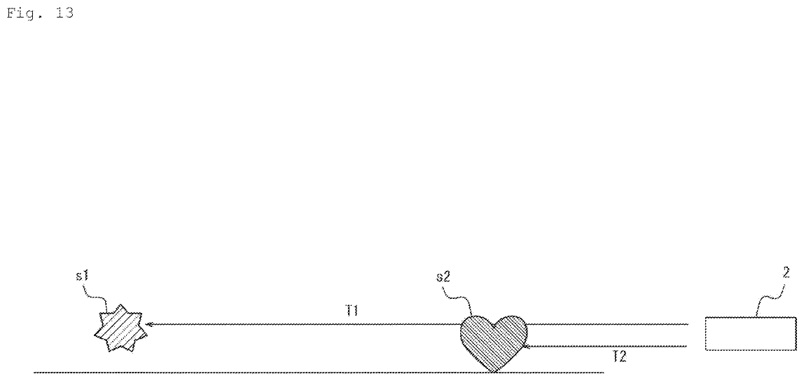

The image display device 10 according to the present embodiment displays the image photographed by the imaging device 2 on the display devices 3b and 3f. Specifically, the image display device 10 displays the subject in the image photographed by the imaging device 2 on the display devices 3b and 3f so that the display image of the display device 3b and the display image of the display device 3f are superimposed and visually recognized by the viewer. In the following description, an example in which the image display device 10 displays a subject s1 located on the back side as viewed from the imaging device 2 and a subject s2 located on the front side as viewed from the imaging device 2 as display targets on the devices 3b and 3f as shown in FIG. 13 will be described. Note that the image display device 10 may display not only the image photographed by the imaging device 2 but also the subject included in the image reproduced by a reproduction device on the display devices 3b and 3f. Therefore, a source that inputs images including the display target to the image display device 10 is not limited to the imaging device 2.

Next, the functional configuration of the image display device 10 according to the present embodiment will be described with reference to FIG. 2.

As shown in FIG. 2, the image display device 10 according to the present embodiment includes a subject extraction unit 11, a subject depth measurement unit 12 as a measurement unit, and a display destination determination unit 13 as a display control unit. The subject extraction unit 11, the subject depth measurement unit 12, and the display destination determination unit 13 may be configured by dedicated hardware such as an ASIC (Application Specific Integrated Circuit) or an FPGA (Field-Programmable Gate Array). Alternatively, as described above, these units may be configured by one or more processors or may be configured to include both.

The subject extraction unit 11 extracts subjects (subjects s1 and s2), which are display targets, from the image photographed by the imaging device 2 and outputs the subjects to the subject depth measurement unit 12. The extraction of the subject by the subject extraction unit 11 can be performed using any image processing technique or using a model learned by any deep learning technique.

The subject depth measurement unit 12 measures the distance in the depth direction of each subject extracted by the subject extraction unit 11 from a predetermined position (for example, the position of the imaging device 2). Measurement of the distance in the depth direction of the subject by the subject depth measurement unit 12 can be performed using any image processing technique or using a model learned by any deep learning technique. The subject depth measurement unit 12 may measure the distance of the subject in the depth direction using a depth sensor. The subject depth measurement unit 12 outputs the measurement result of the distance of each subject in the depth direction to the display destination determination unit 13.

The display destination determination unit 13 determines whether the display destination of the subject will be the display device 3b or the display device 3f based on the measurement result of the depth direction of the subject, which is the display target, measured by the subject depth measurement unit 12. That is, the display destination determination unit 13 as a display control unit displays the subject on either the display device 3b as the first display device or the display device 3f as the second display device based on the measured distance of the subject in the depth direction.

By doing so, the display device 3 on which the display target is displayed is switched in accordance with the movement of the display target in the depth direction, so that a more realistic image can be presented without impairing the realistic sense of depth.

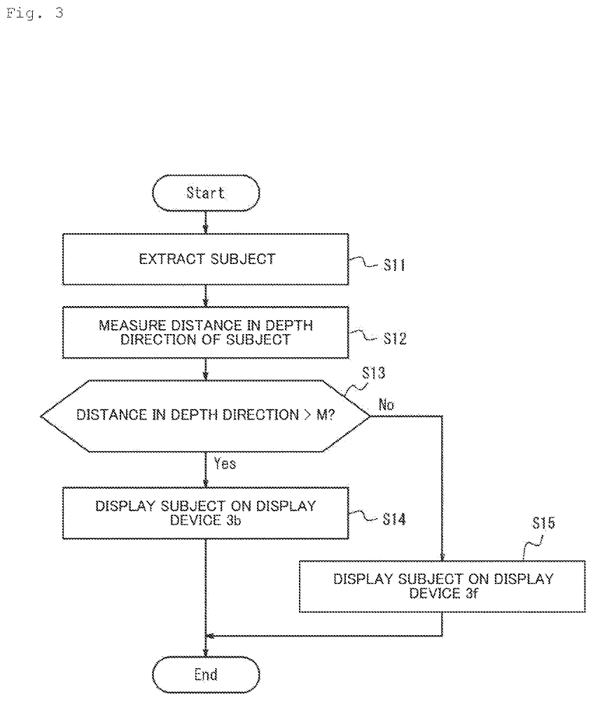

Next, the operation of the image display device 10 according to the present embodiment will be described. FIG. 3 is a flowchart showing an example of the operation of the image display device 10 according to the present embodiment, and is a diagram for explaining an image display method in the image display device 10.

The subject extraction unit 11 extracts a display target subject from the image photographed by the imaging device 2 (step S11).

The subject depth measurement unit 12 measures the distance in the depth direction of the extracted subject when viewed from the viewer (step S12).

The display destination determination unit 13 determines whether the measured distance of the subject in the depth direction is greater than a predetermined threshold value M (step S13). The threshold M is the distance to a predetermined point between the display device 3b and the display device 3f when viewed from the viewer.

When it is determined that the distance of the subject in the depth direction is greater than the threshold value M (step S13: Yes), the display destination determination unit 13 determines that the display destination of the subject is the display device 3b, and displays the subject on the display device 3b (step S14).

When it is determined that the distance of the subject in the depth direction is equal to or less than the threshold value M (step S13: No), the display destination determination unit 13 determines that the display destination of the subject is the display device 3f, and displays the subject on the display device 3f (step S15).

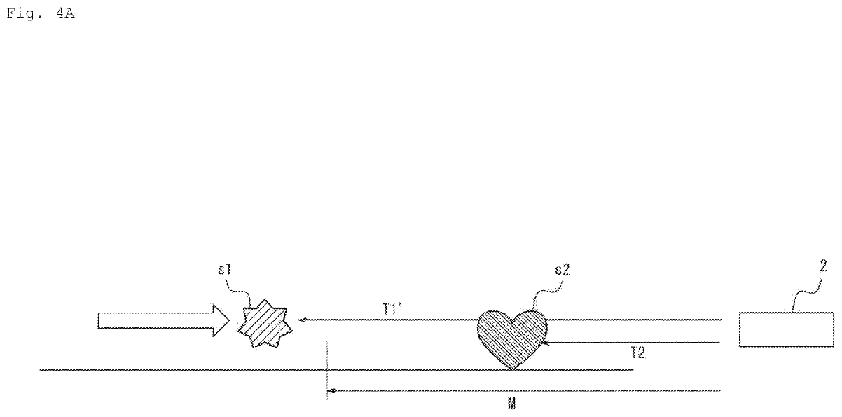

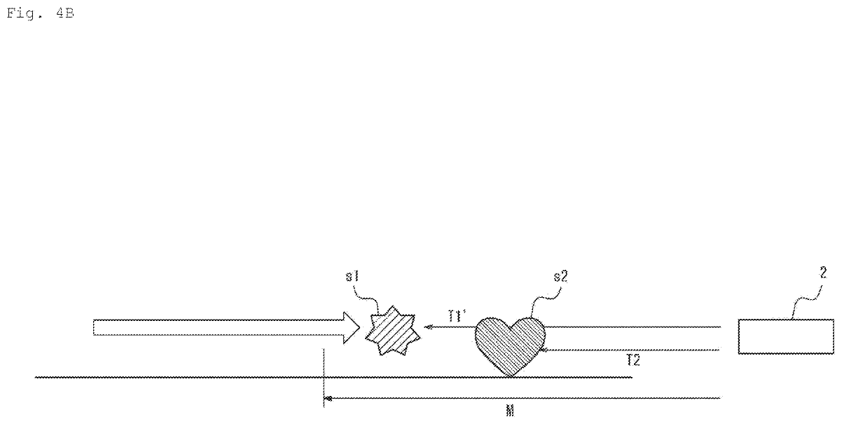

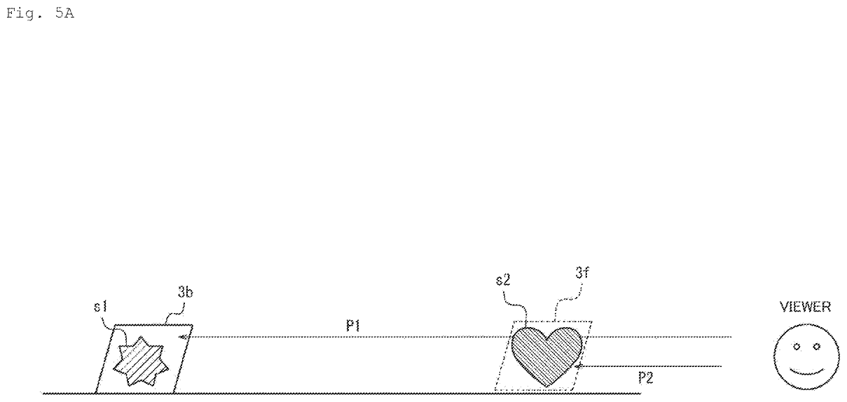

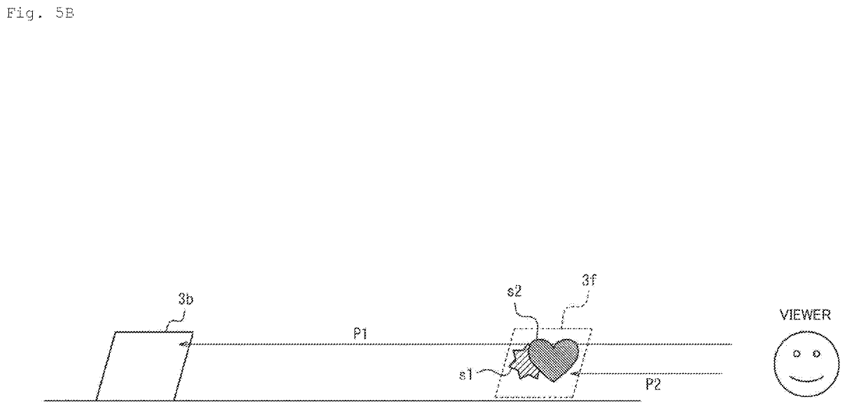

The operation of the image display device 10 according to the present embodiment will be described more detail with reference to FIGS. 4A to 5B. In the following, as shown in FIGS. 13 and 14, a case in which a subject s1 moves toward the imaging device 2 from the state where the subject s1 present at a distance T1 from the imaging device 2 is displayed on the display device 3b, and a subject s2 present at a distance T2 from the imaging device 2 is displayed on the display device 3f will be considered.

In this case, as shown in FIG. 4A, when the distance T1′ of the subject s1 in the depth direction is greater than the threshold value M, the display destination determination unit 13 displays the subject s1 on the display device 3b as shown in FIG. 5A.

When the subject s1 moves further and the distance T1′ of the subject s1 in the depth direction becomes equal to or less than the threshold value M as shown in FIG. 4B, the subject s1 is displayed on the display device 3f together with the subject s2.

In FIGS. 4A to 5B, an example of switching the display destination of the subject s1 in accordance with the movement of the subject s1 has been described, but the present disclosure is not limited to this. When the subject s2 moves toward the back side, the display destination of the subject s2 may be switched from the display device 3f to the display device 3b in accordance with the movement of the subject s2.

As described above, the image display device 10 according to the present embodiment includes the subject depth measurement unit 12 as a measurement unit and the display destination determination unit 13 as a display control unit. The subject depth measurement unit 12 measures the distance in the depth direction of display targets (subjects s1 and s2) when viewed from the viewer (user).

The display destination determination unit 13 displays the display target on either the display device 3b as the first display device or the display device 3f as the second display device based on the measured distance.

Further, the image display method in the image display device 10 according to the present embodiment includes a measurement step (step S12) and a display step (steps S13 to S15). In the measurement step, the distance in the depth direction of the display targets (subjects s1 and s2) when viewed from the viewer (user) is measured. In the display step, the display target is displayed on either the display device 3b as the first display device or the display device 3f as the second display device based on the measured distance.

By displaying the display target on either the display device 3b or the display device 3f based on the distance in the depth direction of the display target when viewed from the viewer, the display device 3 on which the display target is displayed is switched in accordance with the movement of the display target. Thus, more realistic images can be presented without impairing the realistic sense of depth.

### Second Embodiment

In the image display device 10 according to the first embodiment, when the subject s1 on the back side continuously moves to the front side, the display destination of the subject s1 is switched from the display device 3b to the display device 3f at a certain time point. By adjusting the positions of the display devices 3b and 3f so that the position of the subject s1 does not change before and after the switching at the position of a certain viewer (hereinafter referred to as the “reference viewing position”) at the time point when the display destination is switched, it is possible to prevent a positional deviation of the subject s1 at the reference viewing position. However, at a position (hereinafter referred to as “non-reference viewing position”) deviated from the reference viewing position, a positional deviation of the display target visually recognized by the viewer occurs due to the switching of the display destination of the display target.

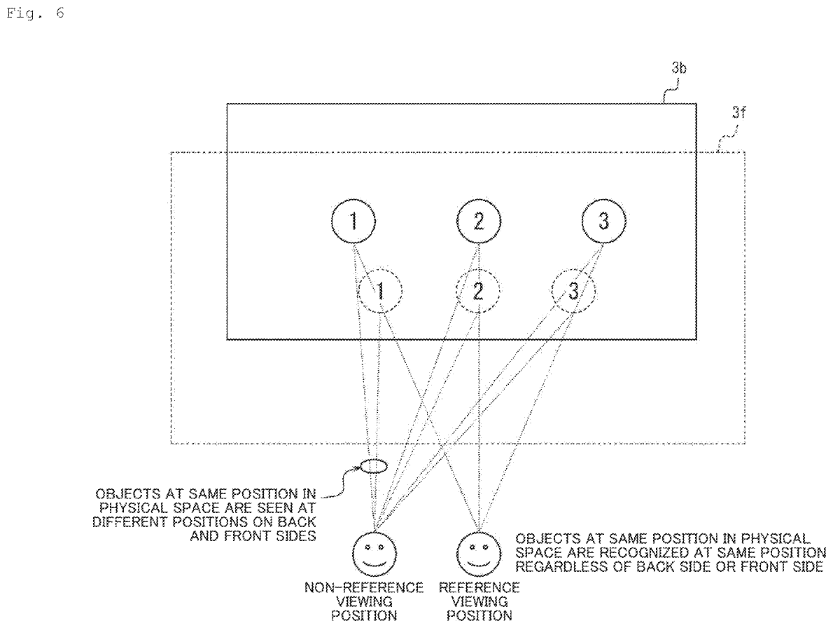

FIG. 6 is a diagram showing a state in which an object in a physical space is projected onto the display device 3f and the display device 3b. In FIG. 6, the solid-line circles with numbers indicate the positions of the objects in the physical space projected onto the display device 3b, and the broken-line circles with numbers indicate the positions of the objects in the physical space projected onto the display device 3f. In FIG. 6, black-line circles and broken-line circles with the same numbers respectively indicate the positions of the same object in the physical space projected onto the display device 3b and the display device 3f.

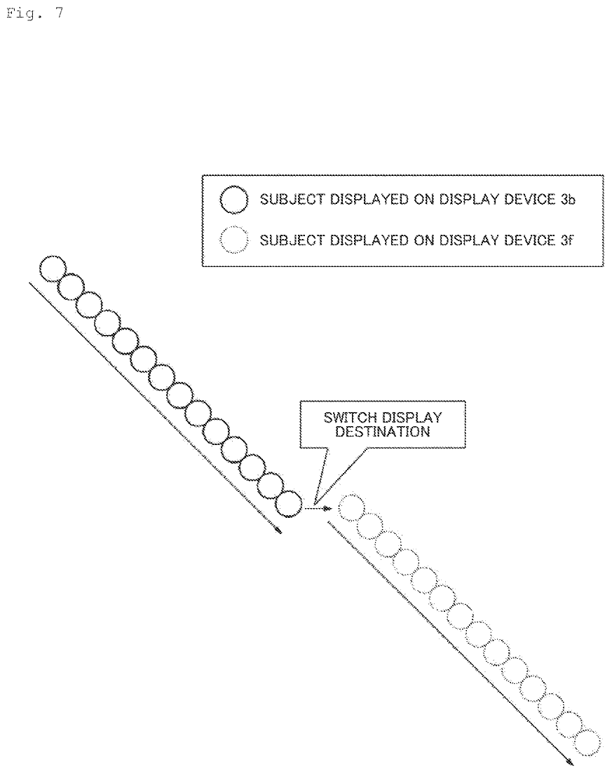

As shown in FIG. 6, when viewed from the reference viewing position, the objects at the same position in the physical space are visually recognized at the same position regardless of the back-side display device 3b or the front-side display device 3f. Therefore, at the reference viewing position, when the display destination of the display target is switched, a positional deviation of the display target to be visually recognized does not occur. On the other hand, at the non-reference viewing position, an object at the same position in the physical space is visually recognized at different positions on the back-side display device 3b and the front-side display device 3f. Therefore, at the non-reference viewing position, when the display destination of the display target is switched, a positional deviation of the display target to be visually recognized occurs. Therefore, when the display destination of the display target is switched, the display target appears to move discontinuously for the viewer viewing from the non-reference viewing position as shown in FIG. 7. The present embodiment aims to deal with this problem.

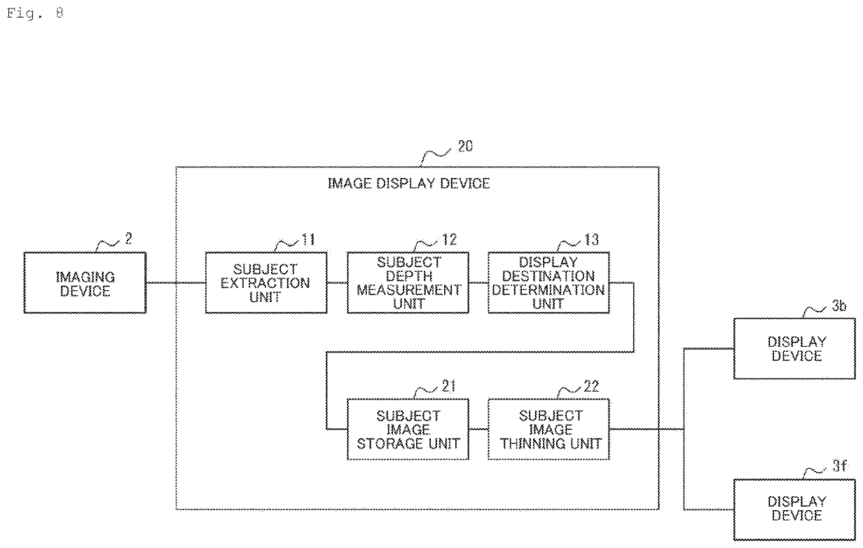

FIG. 8 is a diagram showing a functional configuration example of an image display device 20 according to a second embodiment of the present disclosure. In FIG. 8, the same components as in FIG. 2 are denoted by the same reference numerals, and the description thereof is omitted.

As shown in FIG. 8, the image display device 20 according to the present embodiment includes the subject extraction unit 11, the subject depth measurement unit 12, the display destination determination unit 13, a subject image storage unit 21, and a subject image thinning unit 22. The image display device 20 according to the present embodiment differs from the image display device 10 according to the first embodiment in that the subject image storage unit 21 and the subject image thinning unit 22 are added.

The subject image storage unit 21 stores images (image frames) of a subject which is a display target, and outputs them to the subject image thinning unit 22 with a delay of a predetermined time.

When the display destination determination unit 13 determines to switch the display destination of the subject, the subject image thinning unit 22 thins out the subject image frames output from the subject image storage unit 21 in a predetermined period before and after the switching and outputs the image frames to the display device 3 determined as the display destination by the display destination determination unit 13. That is, when switching the display device 3 that displays the display target, the subject image thinning unit 22 thins out the subject image frames in a predetermined period before and after switching.

The operation of the subject image thinning unit 22 will be described in more detail. An example in which a subject which is a display target moves from the back side to the front side, and the display destination of the subject image is switched from the display device 3b to the display device 3f in accordance with the movement of the subject will be described.

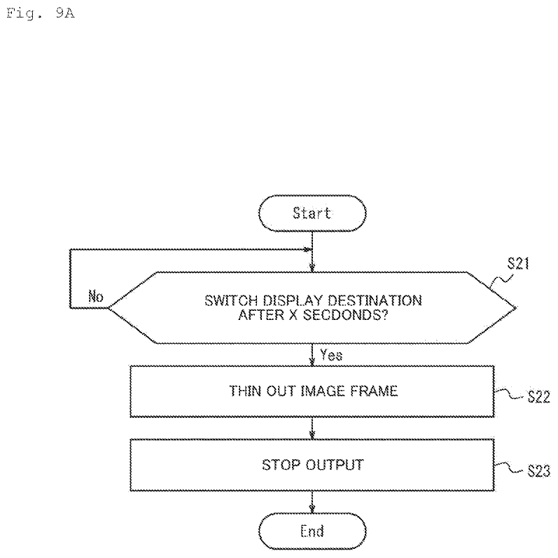

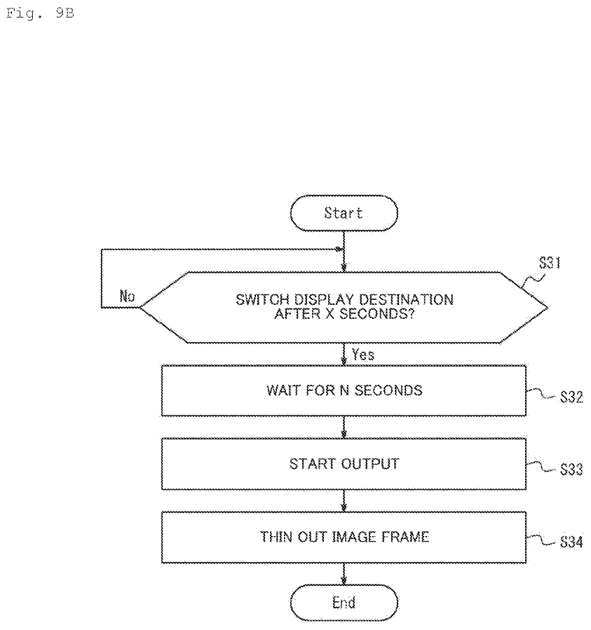

FIG. 9A is a flowchart showing an example of the operation of the subject image thinning unit 22 regarding display of the subject image on the display device 3b when the display destination is switched from the display device 3b to the display device 3f.

The subject image thinning unit 22 determines whether the subject display destination will be switched from the display device 3b to the display device 3f after X seconds (step S21).

If it is determined that the subject display destination will not be switched after X seconds (step S21: No), the subject image thinning unit 22 repeats the process of step S21.

When it is determined that the subject display destination will be switched after X seconds (step S21: Yes), the subject image thinning unit 22 thins out the image frames of the display target subject (step S22).

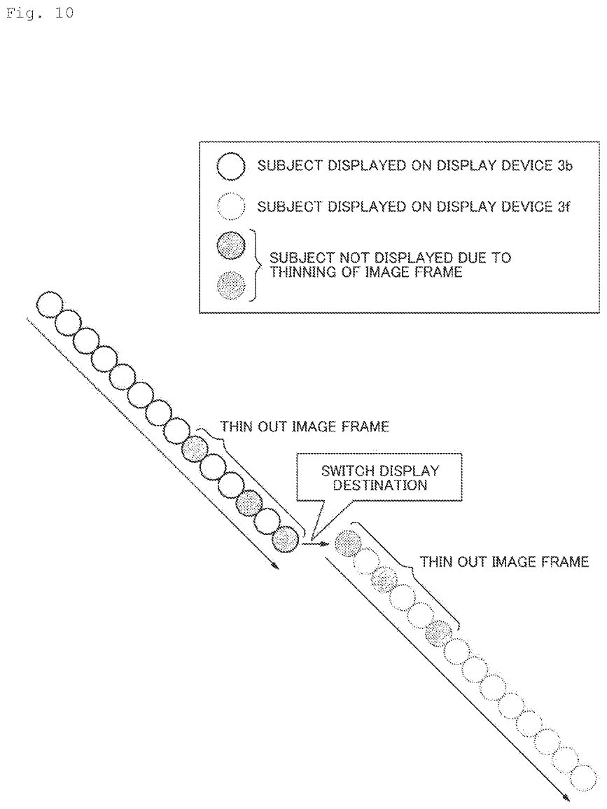

FIG. 10 is a diagram illustrating an example of subject display before and after switching the display destination.

As shown in FIG. 10, the subject image thinning unit 22 thins out the subject image frames from a predetermined time (6 frames in the example of FIG. 10) before the switching of the display destination. Therefore, the subject is not displayed in the thinned image frames.

Referring to FIG. 9A again, when X seconds has elapsed after it is determined that the subject display destination will be switched after X seconds, since the subject display destination is switched from the display device 3b to the display device 3f, the subject image thinning unit 22 stops the output of image frames to the display device 3b (step S23).

FIG. 9B is a flowchart showing an example of the operation of the subject image thinning unit 22 regarding display of the subject image on the display device 3f when the display destination is switched from the display device 3b to the display device 3f.

The subject image thinning unit 22 determines whether the subject display destination will be switched from the display device 3b to the display device 3f after X seconds (step S31).

If it is determined that the subject display destination will not be switched after X seconds (step S31: No), the subject image thinning unit 22 repeats the process of step S31.

When it is determined that the display destination of the subject will be switched after X seconds (step S31: Yes), the subject image thinning unit 22 waits for X seconds (step S32).

After determining that the subject display destination will be switched after X seconds, when X seconds has been waited and the display destination is switched, the subject image thinning unit 22 starts the output of the subject image frames to the display device 3f (step S33).

When the subject image frames are output to the display device 3f by switching the display destination, the subject image thinning unit 22 thins out the image frames of the display target subject (step S34). Specifically, as shown in FIG. 10, the subject image thinning unit 22 thins out the subject image frames until a predetermined time (6 frames in the example of FIG. 10) elapses after the display destination is switched. After a predetermined time has passed, the subject image thinning unit 22 ends thinning out of the subject image frames.

As described with reference to FIGS. 9A, 9B, and 10, when the display device 3 that displays the display target subject is switched, the subject image thinning unit 22 thins out the display target image frames in a predetermined period before and after switching. Here, as shown in FIG. 10, the subject image thinning unit 22 thins out the image frames more frequently as it approaches the timing for switching the display destination of the subject. By doing so, when the display target subject is visually recognized so as to move discontinuously at the non-reference viewing position, the amount of change in the position of the subject in the moving direction can be reduced.

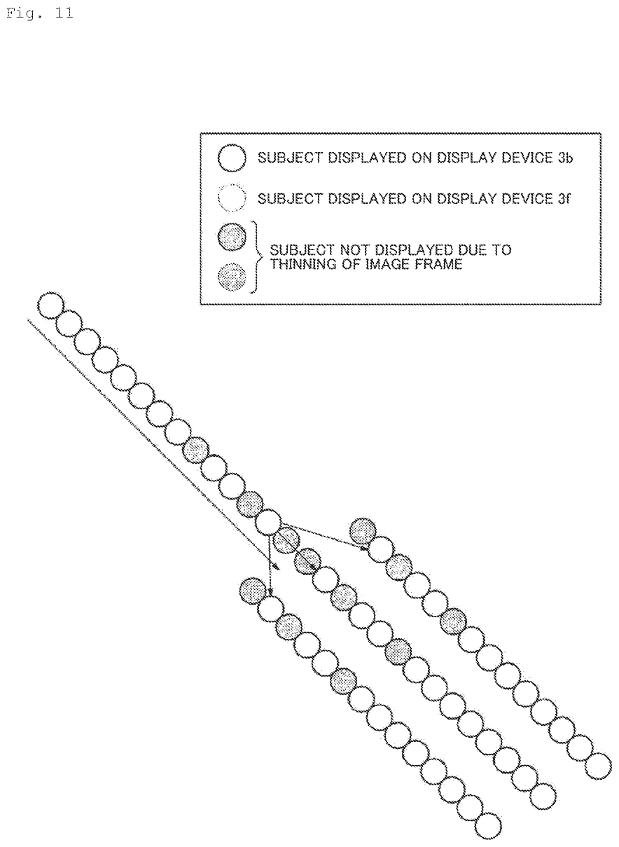

Note that, as shown in FIG. 11, at the non-reference viewing position, the positional deviation of the subject due to switching of the display destination of the subject appears differently depending on the viewing position of the viewer. In the following, a method for further reducing the positional deviation of the subject accompanied by switching of the display destination of the subject at the non-reference viewing position will be described.

The subject image thinning unit 22 prepares in advance a plurality of thinning patterns (pattern 1 to pattern N) for thinning out subject image frames. Patterns 1 to N are patterns that differ from each other in at least one of the number of display target image frames to be thinned out and the timing of thinning out image frames.

The subject image thinning unit 22 selects one thinning pattern from among a plurality of thinning patterns based on the amount of change in the moving direction of the display target accompanied by the switching of the display destination and the number of image frames to be thinned out in each thinning pattern. Specifically, the subject image thinning unit 22 defines the following evaluation function.

Evaluation function (thinning pattern N)=Scarcity of change in moving direction of subject during switching+Abundance of thinning amount

In the above evaluation function, the scarcity of change in the moving direction of the subject at the time of switching is defined as follows, for example.

|sin (moving angle of subject before switching−moving angle of subject when switching)|

The smaller this value, the less the change in the moving direction of the subject before and after the switching, so that the viewer does not lose the sense of reality. Also, the abundance of thinning amount is, for example, the number of image frames to be thinned out in each pattern.

The subject image thinning unit 22 searches for N that minimizes the following equation (1).

$$\begin{matrix}[ Formula 1 ] & \\ {\sum }_{Viewing position} Evaluation function ( Thinning pattern ) & Formula 1\end{matrix}$$

In Equation (1), the viewing position is, for example, a position group of audience seats in a hall using the image display system 1 according to the present disclosure. Since the positions of the subject displayed on the display device 3b and the subject displayed on the display device 3f deviate differently depending on the viewing position, the sense of reality felt by all viewers can be enhanced as much as possible by minimizing the sum of the values of the evaluation at all viewing positions.

All documents, patent applications, and technical standards mentioned in this specification are incorporated herein by reference to the same extent as if each individual document, patent application, or technical standard were specifically and individually indicated to be incorporated by reference.

While one embodiment has been described above as a typical example, it is clear for a person skilled in the art that many alterations and substitutions are possible without departing from the subject matter and scope of the present disclosure. Therefore the embodiment described above should not be interpreted as limiting and the present invention can be modified and altered in various ways without departing from the scope of the claims.

### REFERENCE SIGNS LIST

1 Image display system
2 Imaging device
3b Display device (first display device)
3f Display device (second display device)
10, 20 Image display device
11 Subject extraction unit
12 Subject depth measurement unit (measurement unit)
13 Display destination determination unit (display control unit)
21 Subject image storage unit
22 Subject image thinning unit (thinning unit)
110 Processor
120 ROM
130 RAM
140 Storage
150 Input unit
160 Display unit
170 Communication I/F
190 Bus

1. An image display method comprising:
measuring a distance in a depth direction of a display target from a viewpoint of a user; and
displaying, based on the measured distance in the depth direction, the display target on a first display device as first content, wherein the first display device is located in front of a second display device from the viewpoint of the user, and the second display device displays second content, thereby the user visually recognizes the first content and the second content as being superimposed.

2. The image display method according to claim 1, further comprising:
thinning out display of image frames of the display target in a predetermined period before and after switching of displaying the display target from the first display device to the second display device.

3. The image display method according to claim 2, wherein
a number of image frames to be thinned out increases as a timing of switching the display of the display target from the first display device and the second display device approaches.

4. The image display method according to claim 2, wherein
one thinning pattern is selected from a plurality of thinning patterns different in at least one of the number of image frames to be thinned out of the display target and a timing of the thinning out the image frames based on an amount of change in a moving direction of the display target accompanied by the switching and the number of image frames to be thinned out in each thinning pattern and thins out the image frames according to the selected thinning pattern.

5. An image display device comprising a processor configured to execute operations comprising:
measuring a distance in a depth direction of a display target from a viewpoint of a user; and
displaying, based on the measured distance in the depth direction, the display target on a first display device as first content, wherein the first display device is located in front of a second display device from the viewpoint of the user, and the second display device displays second content, thereby the user visually recognizes the first content and the second content as being superimposed.

6. A computer-readable non-transitory recording medium storing computer-executable program instructions that when executed by a processor cause a computer system to execute operations comprising:
measuring a distance in a depth direction of a display target from a viewpoint of a user; and
displaying, based on the measured distance in the depth direction, the display target on a first display device as first content, wherein the first display device is located in front of a second display device from the viewpoint of the user, and the second display device displays second content, thereby the user visually recognizes the first content and the second content as being superimposed.

7. The image display device according to claim 5, the processor further configured to execute operation comprising:
thinning out display of image frames of the display target in a predetermined period before and after switching of displaying the display target from the first display device to the second display device.

8. The image display device according to claim 7, wherein
a number of image frames to be thinned out increases as g a timing of switching the display of the display target from the first display device and the second display device approaches.

9. The image display device according to claim 7, wherein
one thinning pattern is selected from a plurality of thinning patterns different in at least one of the number of image frames to be thinned out of the display target and a timing of the thinning out the image frames based on an amount of change in a moving direction of the display target accompanied by the switching and the number of image frames to be thinned out in each thinning pattern and thins out the image frames according to the selected thinning pattern.

10. The computer-readable non-transitory recording medium according to claim 6, the computer-executable program instructions when executed further causing the computer system to execute operations comprising:
thinning out display of image frames of the display target in a predetermined period before and after switching of displaying the display target from the first display device to the second display device.

11. The computer-readable non-transitory recording medium according to claim 10, wherein
a number of image frames to be thinned out increases as a timing of switching the display of the display target from the first display device and the second display device approaches.

12. The computer-readable non-transitory recording medium according to claim 10, wherein
one thinning pattern is selected from a plurality of thinning patterns different in at least one of the number of image frames to be thinned out of the display target and a timing of the thinning out the image frames based on an amount of change in a moving direction of the display target accompanied by the switching and the number of image frames to be thinned out in each thinning pattern and thins out the image frames according to the selected thinning pattern.
